(19) United States
(12) Patent Application Publication
(10) Pub. No.: US 2007/0214631 A1
(43) Pub. Date: Sep. 20, 2007

(54) Thermal chuck and processes for manufacturing the thermal chuck

(76) Inventor: Thomas Landrigan, Littleton, MA (US)

Correspondence Address: CANTOR COLBURN, LLP, 55 GRIFFIN ROAD SOUTH, BLOOMFIELD, CT, 06002, US

(21) Appl. No.: 11/377,841

(22) Filed: Mar. 15, 2006

(51) Int. Cl. B21B 1/46; B23P 21/00; B23P 19/04

(52) U.S. Cl. 29/527.1; 29/527.5; 29/469; 29/243

(57) ABSTRACT

Thermal chucks for processing semiconductor substrates include a cooling passage that provides a laminar flow. The thermal chuck can be fabricated by forming the cooling passage into a selected one of a planar support surface portion and an underside portion; sandwiching a cladding material between the planar support surface portion and the underside portion to form a thermal chuck assembly; and heating the thermal chuck assembly to a temperature and under conditions to fuse the cladding material to the planar support surface portion and the underside portion, wherein the cooling passage is sealed therein. The cooling passage can be milled or cast and has radially curved section connected to adjacent linear sections to form a serpentine-like shape.

### BACKGROUND

The present disclosure generally relates to the manufacture of thermal chucks employed in semiconductor processing, and more particularly, to thermal chucks having cooling passages formed therein and for methods of manufacturing the thermal chuck with the cooling passages.

Thermal chucks are generally manufactured from a unitary member having a defined height, width, and thickness. For processing semiconductor substrates, the thermal chucks are circular and have a planar support surface. Cooling passages formed in these chucks generally have a serpentine-like shape so as to provide uniform temperature regulation and control during use. To make the serpentine-like shape of the cooling passage, prior art chucks are drilled at edge locations radially disposed about the chuck. Each linear drilled passage intersects with another drilled passage so as to form the serpentine like-shape. Inlet and outlet openings are formed at the terminal ends of the serpentine-like shape cooling passage, which in the course of manufacture are drilled through the underside of the chuck. The drill hole openings about the radial edge of the chuck are then press fitted with a plug, e.g., a two-piece friction lock plug.

FIG. 1 illustrates an exemplary thermal chuck 10 that includes a serpentine-like shaped cooling passage. The illustrated thermal chuck 10 is circular in shape having a planar support surface 12 for supporting substrates during processing. Concentric recesses 14 may be formed in the planar support surface 12 to provide vacuum hold down capabilities. In this exemplary chuck, eleven passageways 16 are drilled through the radial edge 18 of the chuck to collectively form the serpentine-like shaped cooling passage. Inlet and outlet openings 20, 22 are drilled through the underside of the chuck at terminal end locations for the serpentine-like shape cooling passage. The openings 24 about the radial edge 18 are then press fitted with a 2-piece plug (not shown).

One of the problems with manufacturing the cooling passages in this manner is that the press fitted plugs can fail during operation causing fluid to leak into the process chamber during use. The press fitted-plugs are generally rated for temperatures significantly less than the operating temperatures in which the thermal chuck is exposed. However, in practice the chuck is routinely used in excess of these temperatures, which can result in thermal fatigue and failure of the plugs. Moreover, the process of press fitting the plugs into openings can result in distortion of the planar support surface 12 and affect the mechanical integrity of the chuck. Although the distortion can generally be resolved by milling excess material from the distorted surface, to a desired flatness specification, residual stress concentrations coupled with thermal cycling can cause the chuck to fracture.

Another problem inherent to the method of manufacture of the serpentine-like cooling passage is the transitional/turbulent flow of coolant inherent to the manner in which the cooling passage is formed. Because the serpentine-like cooling passage requires each passage section to be drilled linearly from a radial edge location, the intersecting passage sections are at an angle to one another, e.g., perpendicular as shown. The resulting transitional/turbulent flow of fluid therein affects temperature uniformity and can impart mechanical stresses to the chuck. Moreover, the friction fitted plugs have a finite length, which do not always terminate at the point of intersection, thereby resulting in dead ends within the serpentine -like cooling passage. Additionally, liquid is trapped in the dead end portions when the cooling passage is purged with pressurized air. This liquid vaporizes when the thermal chuck is reheated, causing excess pressure within the cooling passage.

Accordingly, there remains a need for improved manufacturing methods and thermal chucks to overcome the problems noted in the art.

### BRIEF SUMMARY

Disclosed herein are thermal chucks having cooling passages machined therein and for methods of manufacturing the thermal chuck. In one embodiment, a process for fabricating the thermal chuck comprises forming a cooling passage into a selected one of a planar support surface portion and an underside portion; sandwiching a cladding material between the planar support surface portion and the underside portion to form the thermal chuck; and heating the thermal chuck to a temperature and under conditions to fuse the cladding material to the planar support surface portion and the underside portion, wherein the cooling passage is sealed therein.

In another embodiment, the process comprises forming a cooling passage into a selected one of a planar support surface portion and an underside portion; sandwiching a cladding material between the planar support surface portion and the underside portion to form a thermal chuck assembly; and vacuum brazing the planar support surface portion, the cladding material, and the underside portion to form a an integrated structure, wherein the cooling passage is sealed within the integrated structure.

A thermal chuck for processing semiconductor substrates comprises a planar top surface for supporting a substrate; a cooling passage spanning underneath the planar top surface comprising a plurality of linear sections and at least one radially curved section connecting adjacent ones of the plurality of linear sections, a first end, and a second end; and a bottom surface having therein an inlet opening fluidly connected to the first end and an outlet opening fluidly connected to the second end, wherein the cooling passage is sandwiched between the planar top surface and the bottom surface.

The above described and other features are exemplified by the following figures and detailed description.

### BRIEF DESCRIPTION OF THE DRAWINGS

Referring now to the figures, which are exemplary embodiments and wherein like elements are numbered alike:

FIG. 1 is a perspective of a prior art thermal chuck;

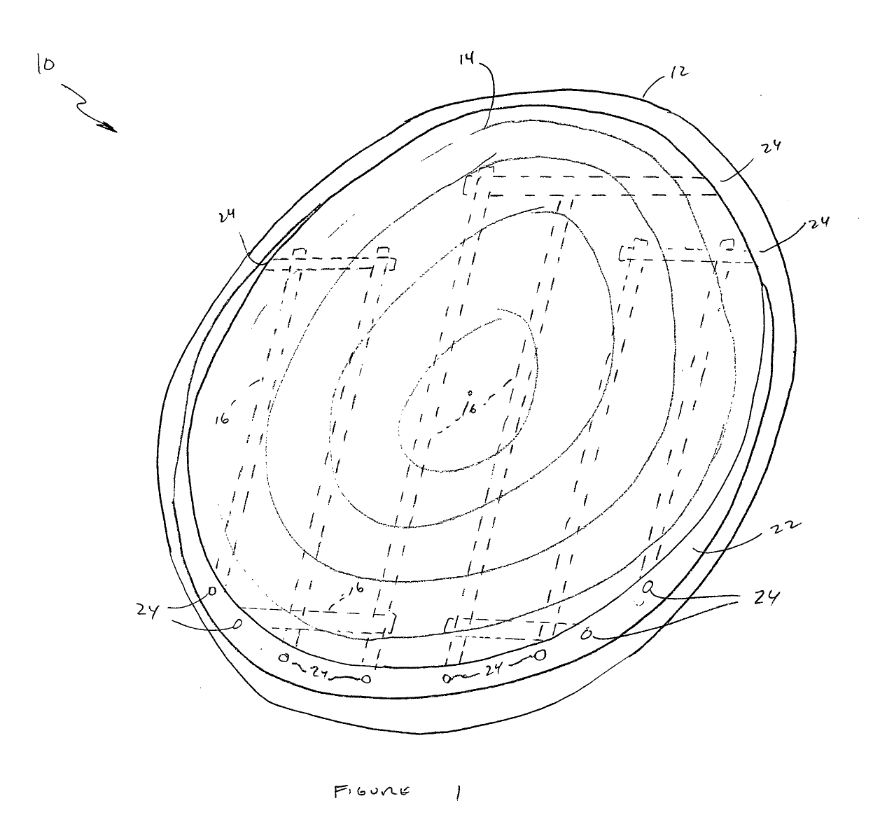

FIG. 2 is an exploded perspective view of a thermal chuck in accordance with one embodiment of the disclosure;

FIG. 3 is a perspective view of the thermal chuck of FIG. 2 detailing the planar support surface for supporting a substrate; and

FIG. 4 is a plan view of a serpentine-like shaped cooling passage in accordance with one embodiment.

### DETAILED DESCRIPTION

Disclosed herein are a thermal chuck that includes cooling passages and a method of manufacturing the thermal chuck, which overcomes the problems noted in the prior art. The method of manufacture generally includes vacuum brazing a planar support surface portion to an underside portion to form the thermal chuck, wherein the cooling passages are milled into a selected one of the planar support surface portion and the underside portion prior to vacuum brazing. Consequently, upon vacuum brazing, the two components are joined together to seal the milled cooling passage. In this manner, the use of plugs is eliminated and the milled pattern can be made to provide a laminar flow through the cooling passages without dead ends.

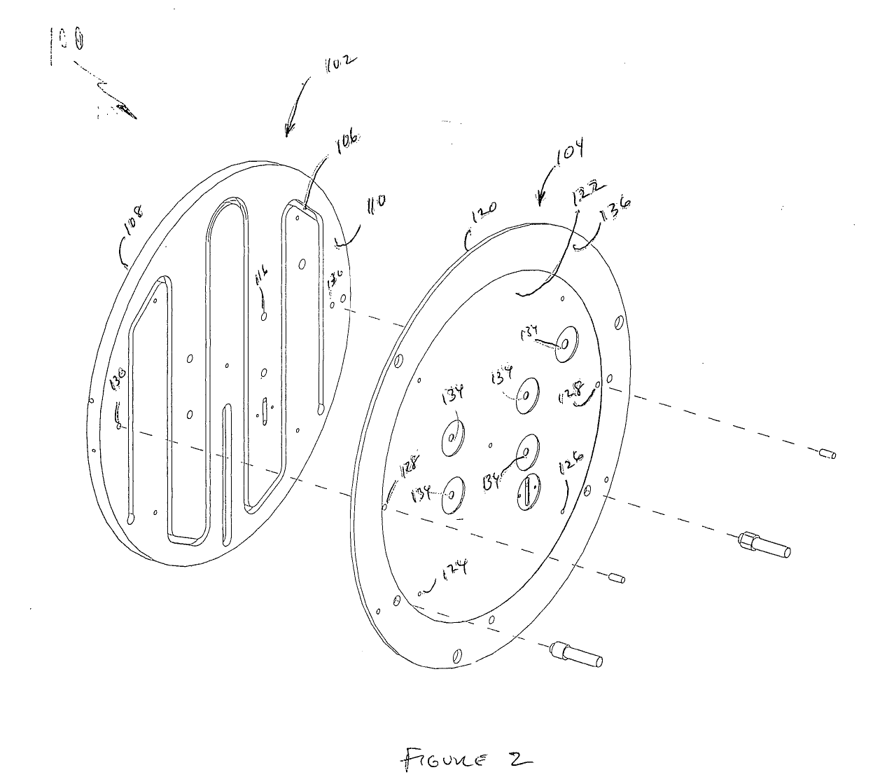

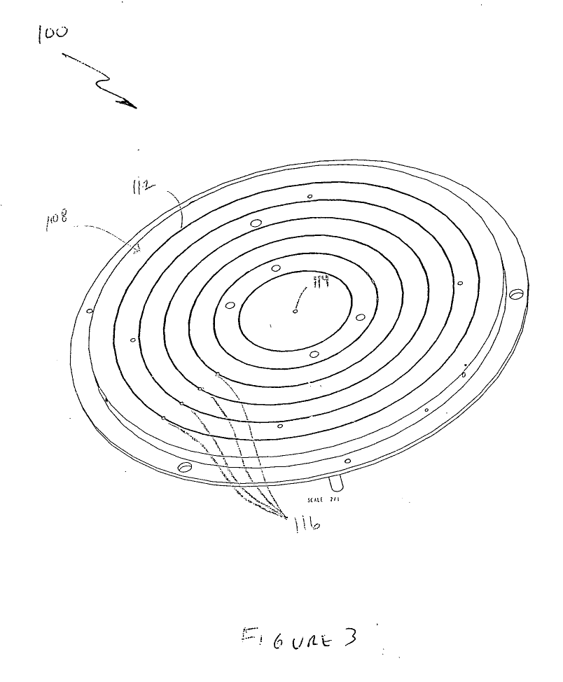

FIGS. 2 and 3 illustrate an exploded view of the thermal chuck 100 in accordance with one embodiment. The thermal chuck 100 generally includes a planar support surface portion 102 and an underside portion 104, wherein one of the selected components (102 or 104) includes a cooling passage pattern 106 milled therein. The planar support surface portion 102 and an underside portion 104 are preferably made of a metal resistant to erosion by the environment in which the thermal chuck is employed, e.g., heat treatable aluminum alloys, aluminum or aluminum alloys with an anodized aluminum oxide coating, and the like.

The planar support surface portion 102 includes a planar top surface 108 upon which a substrate is placed during processing. In the illustrated embodiment, the bottom surface 110 of the planar support surface portion 102 is milled with the desired cooling passage pattern 106. Although a serpentine-like cooling passage pattern is shown, it should be apparent to those skilled in the art that any pattern can be milled therein. As such, the present disclosure is not intended to be limited to the particular pattern shown. Moreover, it should be apparent that more than one passage (i.e., more than one inlet and outlet) could be provided. Additionally, although reference has been made to milling, other methods for defining the cooling passage can be employed, e.g., casting.

The planar support surface portion 102 can also include those features commonly found in thermal chucks employed for processing semiconductor wafers. For example, as shown, the planar top surface 106 may include a plurality of concentric annular recesses 112 about a central axis 114. In addition, the planar support surface portion 102 may optionally include openings 116 for attachment of perimeter pins, heating elements, gas transfer holes, thermocouples, and the like. Depending on the desired application, the openings 116 I combination with the concentric annular recesses 112 may also be employed for providing a vacuum to the backside of the substrate for increasing the number of contact points between the bottom surface of the substrate and the planar top surface 106 such as by elastic deformation of the substrate. If a vacuum hold down is utilized, the increased number of contact points between the substrate and the planar top surface 106 resulting from the vacuum can increase the rate at which the substrate comes to process temperature. In this case, the vacuum hold down openings and/or vacuum passages (not shown) are preferably connected to a vacuum line, which is in turn connected downstream of a process chamber isolation valve, a flow control valve, or the like (not shown).

The underside portion 104 includes a top surface 120 and a bottom surface 122. The top surface is co-planar to and is mated with the bottom surface 122 of the planar support surface portion 102. An inlet 124 and an outlet 126 for the cooling passage 106 may be drilled through the underside portion 104. The underside portion 104 may further include one or more plug openings 128 coaxially aligned with an opening or recess 132 in the planar support surface portion 102. Prior to vacuum brazing, a plug 132 is reamed into the opening 128, 130 to provide the proper alignment of the planar support surface portion 102 with the underside portion 104. The underside portion 104 may further include openings 134 coaxial and complementary to openings 116 in the planar support surface portion 102. In this manner, the thermal chuck 100 can be fitted with thermocouples, perimeter pins and the like, as may be desired for the intended application for the thermal chuck. Resistance heating elements may also be cast into the underside portion 104 enabling elevated processing temperatures that may be utilized for increased tool throughput such as when performing a bulk photoresist strip or etching process. An annular flange 136 circumscribes the bottom surface 122 to provide a means for securing the thermal chuck to a process chamber. The openings can be drilled before or after the vacuum brazing process is complete.

In a preferred embodiment, the operating temperature of thermal chuck can be varied preferably via a feedback or a closed loop control system using a proportional integral derivative (PID) controller having a heating and cooling capability. The controller would alternately supply a current to heating elements or cooling fluid (air or water) to passages 106, as needed. Feedback to the PID controller would be provided by measuring the temperature of substrate during the process using a temperature measuring device such as a spring activated thermocouple mounted within the planar support surface portion 102. For example, a spring is in operable communication with the thermocouple such that the thermocouple maintains contact with the backside surface of substrate. Alternatively, the temperature of the thermal chuck 100 can be controlled with an open loop process (i.e., without a feedback device) by adjusting the current supplied to heating elements and allowing fluid flow (air or water) through passages 106 at the appropriate point in the process. The support 22 is preferably made of a metal resistant to erosion by the process gases, e.g., aluminum with an anodized aluminum oxide coating.

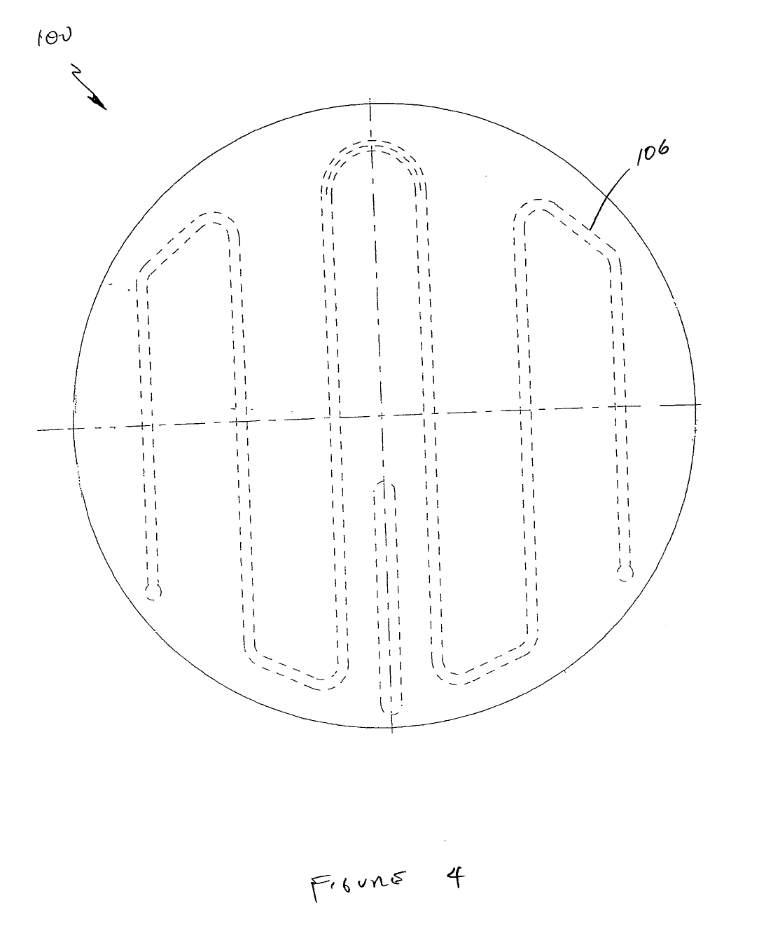

FIG. 4 illustrates a plan view of the serpentine-like cooling passage pattern 110. Noteworthy in the illustrated pattern are the radial curvatures that connect the passage sections that are substantially linear. In this manner, laminar flow through the cooling passage 110 can be obtained.

The vacuum brazing process is a well characterized joining process, whereby a non-ferrous filler metal and an alloy is heated under vacuum to melting temperature (above 450° C.) and distributed between two or more close-fitting parts by capillary action. At its liquid temperature, the molten filler metal interacts with a thin layer of the base metal, cooling to form an exceptionally strong, sealed joint due to grain structure interaction. The brazed joint becomes a sandwich of layers, each metallurgically linked to each other. In order to work properly, the components 102, 104 must be closely fitted and the base metals should be exceptionally clean and free of oxides for achieving the highest strengths for brazed joints. For capillary action to be effective, joint clearances of 0.002 to 0.006 inch (50 to 150 μm) are typically recommended. The vacuum brazing process generally includes a pre-heating step, a series of brazing heating steps, and then a cool down step. The vacuum chamber is generally kept at a vacuum level of 1×10⁻³ pascals (Pa) or less.

When joining aluminum-based materials such as the planar support surface portion 102 and the underside portion 104, the cladding layer typically includes aluminum as the primary component. Other materials are added to the cladding material to lower its melting point below that of the pieces to be joined. Thus, during the vacuum brazing process the cladding material is melted, flows between the pieces and then forms a solid joint when it is cooled. For example, silicon can be included in the cladding material in order to lower the melting point. In addition, the cladding material typically includes added magnesium. The magnesium diffuses during the brazing process thereby breaking up the external aluminum oxide layer, acting as a surface wetting agent. The diffusion or out-gassing of magnesium permits the cladding material to flow between the aluminum pieces and results in braze joint formation. Thus, magnesium is typically added to the cladding material for this function. The cladding material often comprises other components, the selection of which is well within the skill of those in the art.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A process for fabricating a thermal chuck, the process comprising:
forming a cooling passage into a selected one of a planar support surface portion and an underside portion;
sandwiching a cladding material between the planar support surface portion and the underside portion to form the thermal chuck; and
heating the thermal chuck to a temperature and under conditions to fuse the cladding material to the planar support surface portion and the underside portion, wherein the cooling passage is sealed therein.

2. The process of claim 1, wherein heating the thermal chuck is under a vacuum.

3. The process of claim 1, wherein the cladding material is a foil.

4. The process of claim 1, wherein heating is at a temperature greater then a melting point of the cladding material

5. The process of claim 1, wherein forming the cooling passages comprises casting the cooling passages into the selected one of the planar support surface portion and the underside portion.

6. The process of claim 1, wherein forming the cooling passages comprises milling the cooling passages into the selected one of the planar support surface portion and the underside portion.

7. The process of claim 1, wherein forming the cooling passage comprises defining a serpentine-like shaped pattern in a bottom surface of the planar support surface portion, wherein the serpentine-like shaped pattern comprise a plurality of linear sections joined by curved sections to define a continuous passageway.

8. The process of claim 1, wherein the planar support surface portion and the underside portion are formed of an aluminum alloy.

9. The process of claim 1, wherein forming the cooling passage is effective to provide a laminar flow of a fluid through the cooling passage.

10. A process for fabricating a thermal chuck, the process comprising:
forming a cooling passage into a selected one of a planar support surface portion and an underside portion;
sandwiching a cladding material between the planar support surface portion and the underside portion to form a thermal chuck assembly; and
vacuum brazing the planar support surface portion, the cladding material, and the underside portion to form a an integrated structure, wherein the cooling passage is sealed within the integrated structure.

11. The process of claim 10, wherein the planar support surface portion and the underside portion are formed of an aluminum alloy.

12. The process of claim 10, wherein forming the cooling passage comprises casting the cooling passages into the selected one of the planar support surface portion and the underside portion.

13. The process of claim 10, wherein forming the cooling passage comprises milling the cooling passages into the selected one of the planar support surface portion and the underside portion.

14. The process of claim 10, wherein forming the cooling passage comprises defining a serpentine-like shaped pattern in a bottom surface of the planar support surface portion, wherein the serpentine-like shaped pattern comprise a plurality of linear sections joined by curved sections to define a continuous passageway.

15. A thermal chuck for processing semiconductor substrates, the thermal chuck comprising:
a planar top surface for supporting a substrate;
a cooling passage spanning underneath the planar top surface comprising a plurality of linear sections and at least one radially curved section connecting adjacent ones of the plurality of linear sections, a first end, and a second end; and
a bottom surface having therein an inlet opening fluidly connected to the first end and an outlet opening fluidly connected to the second end, wherein the cooling passage is sandwiched between the planar top surface and the bottom surface.

16. The thermal chuck of claim 15, wherein the cooling passage is one continuous passageway from the inlet opening to the outlet opening and is free from any dead ends.

17. The thermal chuck of claim 15, wherein the cooling passage forms a serpentine-like shape.
